(19) United States
(12) Patent Application Publication
(10) Pub. No.: US 2010/0301579 A1
(43) Pub. Date: Dec. 2, 2010

(54) SHEAR CENTER RAISING TWIST AXLE WITH INTERNAL AND TUNABLE TRANSITIONING GUSSETS

(76) Inventors: Aaron J. Smith, Howell, MI (US); Anthony A. Marcheff, Milford, AZ (US); Hari Sankara Iyer, Scottsdale, AZ (US); Dominic G. Perera, Franklin, MI (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/765,183

(22) Filed: Apr. 22, 2010

Related U.S. Application Data
(60) Provisional application No. 61/171,778, filed on Apr. 22, 2009.

(51) Int. Cl. B60G 9/02

(52) U.S. Cl. 280/124.116

(57) ABSTRACT

A trailing rear suspension for a motor vehicle having a twist beam axle coupled at its ends to a pair of trailing arms wherein the twist beam axle raises the shear center of the central portion of its cross-beam above the wheel center of the vehicle. The raising of the shear center is achieved by rotating the cross-beam to orient one leg of its cross-section to be aligned with the top of the trailing arms.

### CROSS-REFERENCE TO RELATED APPLICATION

This application claims the benefit of provisional application no. 61/171778, which is incorporated herein by reference.

### FIELD

The present invention relates generally to a trailing rear suspension used in front wheel drive vehicles and, more particularly, to a twist beam axle for the trailing rear suspension systems.

### BACKGROUND

A trailing rear suspension is commonly used in front wheel drive vehicles. The suspension typically comprises two trailing arms interconnected by a flexible or compliant cross-member beam, i.e., the twist beam axle. The twist beam is typically configured with an open cross section which is rigidly coupled to each trailing arm. The trailing arms support the rear wheels and provide articulation of the axle to the vehicle. The twist beam is designed to enable large torsional displacement over its length, without plastic deformation of the material from which it is formed.

The shear center height of the twist beam plays an important role in rear roll steer effects. Generally, raising the section shear center impinges on the package environment surrounding the twist beam. In order to reduce packaging problems that result from raising the section shear center, suspension designs often require either additional operations or more expensive materials and processing. In addition, maximizing the torsional stiffness of the center twist section of the beam, while managing the stresses using gradual transitioning gussets has been an ongoing challenge in twist beam engineering.

Accordingly, it would be desirable to provide a twist beam axle that raises its shear center above the wheel center of the vehicle.

### SUMMARY

The embodiments provided herein are generally directed to a vehicle trailing rear suspension assembly having first and second trailing arms, and a cross-beam of a twist beam axle coupled to and extending between the first and second trailing arms. The cross-beam preferably has a open cross section with a rear facing opening and a uniform shape extending the length of the cross-beam. The rear suspension preferably includes first and second gussets internally coupled on a first end to the cross-beam of the twist beam axial and coupled on a second end to the first and second the trailing arms. One leg of the cross-section of the cross-beam is preferably aligned with the top of the trailing arm thereby orienting the shear center of the cross-beam adjacent the top of the open cross section of the cross-beam and above the wheel center of the vehicle.

The cross-beam preferably includes a torsional stiffness that is a function of an active length of the cross-beam, wherein the active length of the cross-beam is a function of the length of the first and second gussets.

Other systems, methods, features and advantages of the invention will be or will become apparent to one with skill in the art upon examination of the following figures and detailed description.

### BRIEF DESCRIPTION OF THE DRAWINGS

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a perspective view of a vehicle trailing rear suspension with a twist beam axle.

FIG. 2 is a top view of the vehicle trailing rear suspension shown in FIG. 1.

FIG. 3 is an end view of the vehicle trailing rear suspension shown in FIG. 1.

FIG. 4 is a rear view of the vehicle trailing rear suspension shown in FIG. 1.

FIGS. 5A is a perspective view of an internal gusset of the vehicle trailing rear suspension shown in FIG. 1.

FIGS. 5B is a side elevation view of the internal gusset shown in FIG. 5A.

FIGS. 5C is an end view of the internal gusset shown in FIG. 5A.

FIGS. 5D is a bottom view of the internal gusset shown in FIG. 5A.

FIG. 6 is a perspective view of the cross-beam of twist beam axle shown in FIG. 1.

FIGS. 7 is a cross-sectional view of the cross-beam of the twist beam axle take along line 7-7 in FIG. 6.

FIG. 8 is a side elevation view of the cross-beam of the twist beam axle shown in FIG. 6.

FIG. 9 is a rear view of the cross-beam of the twist beam axle shown in FIG. 6.

FIG. 10 is a cross-sectional view of the vehicle trailing rear suspension taken along line 10-10 in FIG. 3.

### DESCRIPTION

The embodiments and examples provided herein are generally directed to a trailing rear suspension for a motor vehicle having a twist beam axle coupled at its ends to a pair of trailing arms and, more particularly, to a novel twist beam axle for the trailing rear suspension. In the embodiment described herein, the novel twist beam axle raises the shear center of the central portion of the cross-beam above the wheel center of the vehicle, thereby eliminating the need for additional processing or complex cross-sectional shapes for the central portion of the cross-beam of the twist beam axle. The raising of the shear center is achieved by rotating the cross-beam of the twist beam axle to orient one leg of its cross-section to be aligned with the top of the trailing arms, and modifying the cross-sectional shape of the cross-beam of the twist beam axle to optimize the shear center position.

Orienting the shear center above the vehicle wheel center improves the roll steer effects (i.e. adds roll under-steer to the rear suspension) of the trailing rear suspension. Since twist beam axles inherently possess a roll over-steer, which is an undesirable characteristic, raising of the shear center of the twist beam axle and adding roll under-steer to the trailing rear suspension is an advantageous feature of the preferred embodiment whose effects are usually achieved through more expensive means or designs.

Unlike conventional designs, the preferred embodiment has a uniform cross section across the entire span of the cross-beam of the twist beam axle. A uniform cross section allows the cross-beam of the twist beam axle to be roll formed and trimmed, as opposed to requiring several die forming operations. The result is a cross-beam with a continuous cross-sectional shape that can be either die-formed or roll-formed, thus greatly reducing manufacturing costs.

Another aspect of the preferred embodiment is the rearward-open orientation of the cross-beam of the twist beam axle. Air flowing over the cross-beam will pass with more laminar flow than a forward-open orientation, improving the drag coefficient of the vehicle.

The twist beam axle preferably includes U-shape transitioning gussets. Unlike conventional gussets that are located external to the cross-beam of the twist beam axle, the transitioning gussets are preferably internally coupled or welded to the interior of the cross-beam of the twist beam axle and coupled or welded to the trailing arms. The internal gussets advantageously provide a gradual stress distribution and transition between the central portion of the cross-beam of the twist beam axle and the trailing arms. The internal gussets advantageously include an attachment that can be easily modified to increase or decrease the torsional stiffness of the twist beam assembly, making the gussets tunable. As a result, the cross-beam preferably includes a torsional stiffness that is a function of an active length of the cross-beam, wherein the active length of the cross-beam is a function of the length of the internal gussets.

With conventional twist beam designs, the entire center section of the cross-beam of the twist beam axle must be altered in order to accommodate varying torsional stiffness requirements. The preferred embodiment allows for altering torsional stiffness by changing only the gussets. For example, shorter gussets increase the active beam length, thereby reducing torsional stiffness and vise versa. This feature has significant advantages when a vehicle platform requires accommodation of several different vehicle weights. For smaller adjustments to torsional stiffness, which are required during vehicle tuning, minor trim modifications can be made to each gusset to change the amount of torsional rigidity. Because the tunable gussets provide a smooth stress transition between the central portion of the cross-beam of the twist beam axle and the trailing arms, while partially closing the open central portion of the cross-beam, a greater torsional stiffness can be attained using less material. Controlling the torsional stress in the central portion of the cross-beam of the twist beam axle results in the twist beam having improved anti-roll effectiveness.

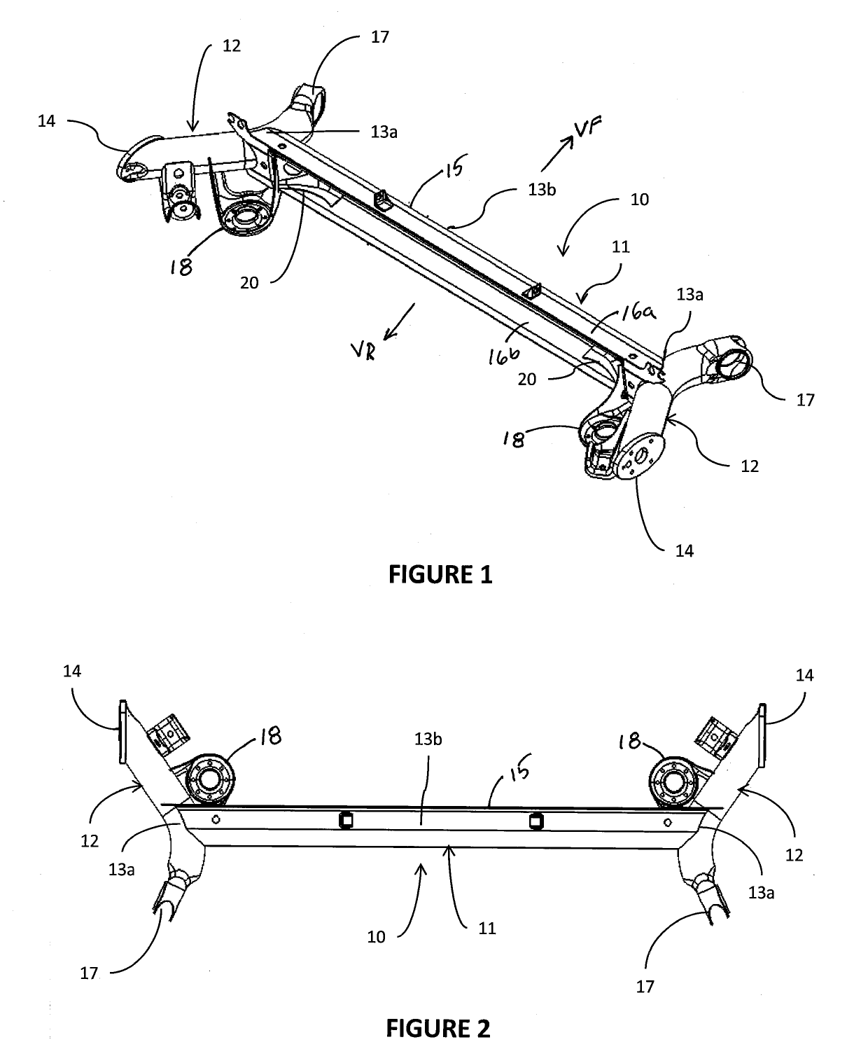

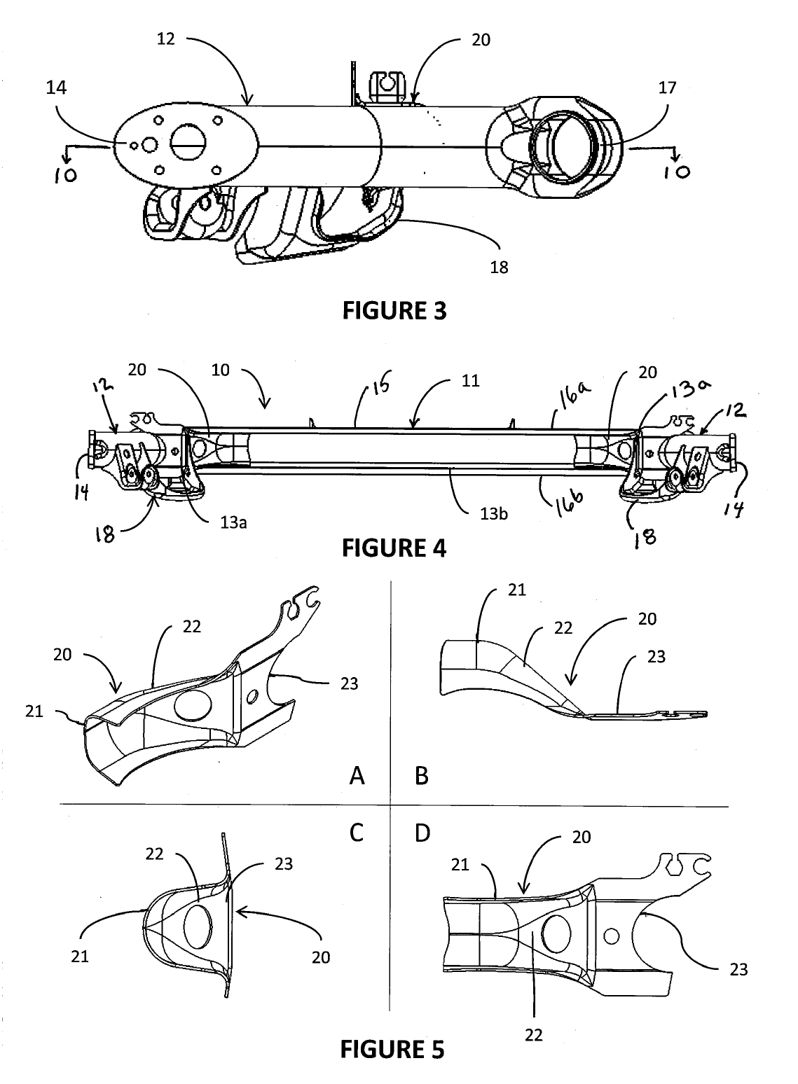

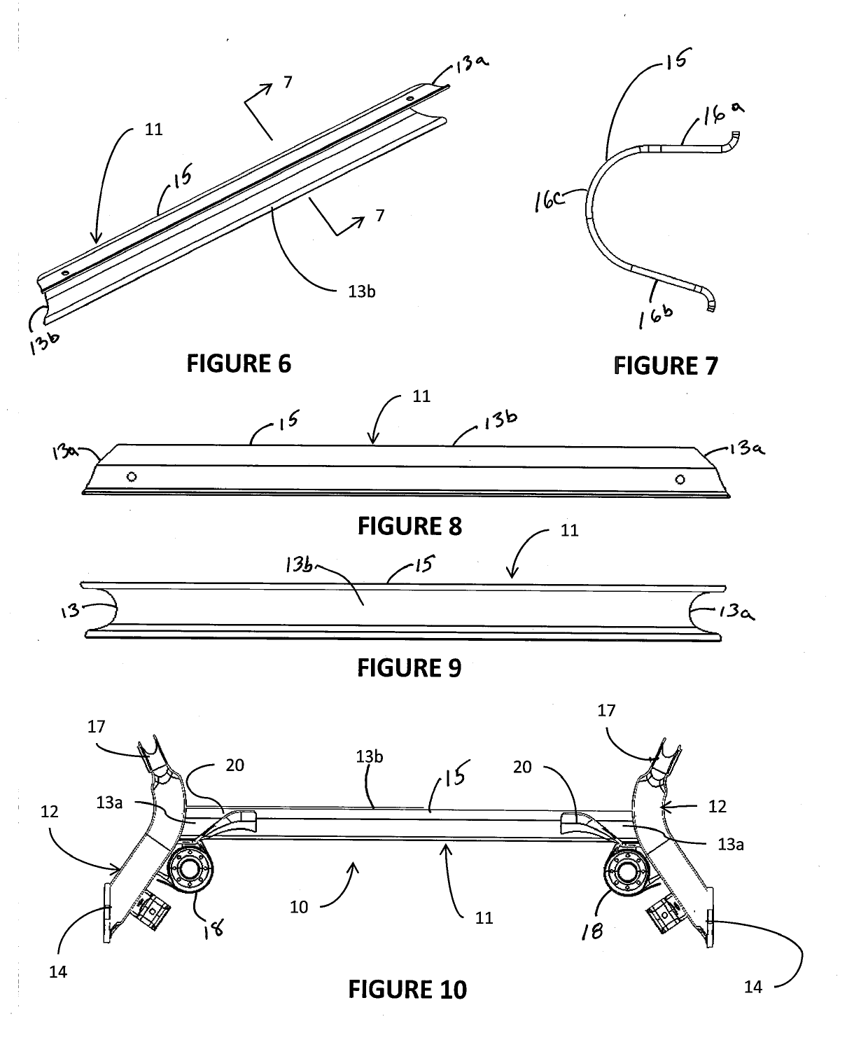

Turning in detail to the figures, FIGS. 1, 2, 3, 4 and 10 provide a variety of views of a preferred embodiment of a trailing rear suspension assembly 10. As depicted, the trailing rear suspension assembly 10 includes a twist beam axle 11 comprising a compliant cross-beam 15, or twist beam, rigidly coupled at its opposing ends 13a to a pair of trailing arms 12. As depicted in FIGS. 6, 7 8 and 9, the cross-beam 15 includes a uniform cross-section extending between its opposing ends 13a through the central portion 13b of the cross beam 15. As shown in FIG. 7, the cross-section of the cross-beam 15 is preferably U shape with an upper leg 16a and a lower leg 16b joined to a arcuate head 16c. Relative to the upper leg 16a, the lower leg 16b is oriented at a downward angle away from the head 16c. Referring back to FIGS. 1 and 4, the upper leg 16a of the cross section of the cross-beam 15 is shown as being aligned with or at the same elevation as the top of the trailing arms 12 thereby positioning the shear center of the cross-beam 15 adjacent the top of the cross-beam 15 and above the vehicle wheel center.

The trailing arms 12 include a wheel mount 14 on a first or rear end of the trailing arms and a bush 17 on a second or forward end of the trailing arms. A spring plate 18 extends from a central region of the trailing arms 12.

As depicted in FIGS. 1, 4 and 10, a pair of gussets 20 are coupled at one end of the gussets 20 to the interior of the cross-beam 15 of the twist beam axle 11 towards the opposing ends 13a of the cross-beam 15 of the twist beam 11 and at the other end of the gussets 20 to the trailing arms 12. Locating the transitioning gusset 20 internal to the cross-beam 15 of the twist beam axle 11 allows stresses to be transitioned from the trailing arms to the center portion 13b of the cross-beam 15 of the twist beam axle 11 using less material than if a conventional external gusset were used.

As shown in FIGS. 5A-C, the internal gussets 20 include a first end 21 with a U shape cross-section, a downwardly inclined central portion 22 (as shown in side elevation FIG. 5B), and a second end 23 comprising a U shape flange. The U shape cross-section of the first end 21 of the gusset 20 enables the first end 21 to be received by and coupled or welded to the interior of the cross-beam 15 of the twist beam axle 11. The U shape flange of the second end 23 is used to couple or weld the gusset to the trailing arm 12.

As shown in FIG. 1, the head 16c of the U shape cross-section of the cross-beam 15 of the twist beam axle is preferably oriented to point toward the front of the vehicle (VF) while the U shape cross-section of the cross-beam 15 opens rearwardly towards the rear of the vehicle (VR).

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

1. A vehicle trailing rear suspension assembly comprising
first and second trailing arms, and
a cross-beam coupled to and extending between the first and second trailing arms, the cross-beam having a open cross section of uniform shape extending the length of the cross-beam and a rear facing opening, wherein the shear center of the cross-beam is positioned adjacent the top of the open cross section of the cross-beam.

2. The assembly of claim 1 further comprising first and second gussets internally coupled on a first end to the cross-beam and coupled on a second end to the first and second the trailing arms.

3. The assembly of claim 1 wherein the open cross section of the cross-beam being U shape and having first and second legs.

4. The assembly of claim 3 wherein in a first leg of the U shaped cross section is aligned with a top of the first and second trailing arms.

5. The assembly of claim 2 wherein the first end of the first and second gussets having a U shape cross section.

6. The assembly of claim 1 wherein the cross-beam includes a torsional stiffness that is a function of an active length of the cross-beam.

7. The assembly of claim 6 wherein the active length of the twist beam is a function of the length of first and second gussets internally coupled on a first end to the cross-beam and coupled on a second end to the first and second the trailing arms.

8. A motor vehicle having a trailing rear suspension assembly, the trailing rear suspension assembly comprising
a twist beam axle having a cross-beam having a open cross section of uniform shape and a rear facing opening extending the length of the cross-beam between first and second ends, and
first and second trailing arms coupled to the first and second ends of the cross-beam, wherein the shear center of the cross-beam is positioned adjacent the top of the open cross section of the cross-beam.

9. The vehicle of claim 8 further comprising first and second gussets internally coupled on a first end to the cross-beam and coupled on a second end to the first and second the trailing arms,

10. The vehicle of claim 8 wherein the open cross section of the cross-beam being U shape and having first and second legs.

11. The vehicle of claim 10 wherein in a first leg of the U shaped cross section is aligned with a top of the first and second trailing arms.

12. The vehicle of claim 9 wherein the first end of the first and second gussets having a U shape cross section.

13. The vehicle of claim 8 wherein the cross-beam includes a torsional stiffness that is a function of an active length of the cross-beam.

14. The vehicle of claim 13 wherein the active length of the twist beam is a function of the length of the first and second gussets .
